(19) United States
(12) Patent Application Publication
(10) Pub. No.: US 2009/0248627 A1
(43) Pub. Date: Oct. 1, 2009

(54) SYSTEM AND METHOD FOR QUERY SUBSTITUTION FOR SPONSORED SEARCH

(75) Inventors: Ben Shahshahani, Menlo Park, CA (US); Vanja Josifovski, Los Gatos, CA (US); Evgeniy Gabrilovich, Sunnyvale, CA (US); Andrei Broder, Menlo Park, CA (US); Filip Radlinski, Ithaca, NY (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 12/056,703

(22) Filed: Mar. 27, 2008

(51) Int. Cl. G06F 17/30

(52) U.S. Cl. 707/3; 707/E17.037

(57) ABSTRACT

A system and method are disclosed for rewriting queries. The queries may be rewritten into a bid phrase for identifying search results and/or advertisements. The bid phrase may be a keyword that is purchased for sponsored searching. A mapping between potential queries and bid phrases may be generated. The mapping may be referenced upon receiving a search query for identifying a query rewrite with a bid phrase for that search query. The mapping may be generated in preprocessing.

### BACKGROUND

The explosive growth of the Internet as a publication and interactive communication platform has created an electronic environment that is changing the way business is transacted. As the Internet becomes increasingly accessible around the world, users need efficient tools to navigate the Internet and to find content available on various websites.

Internet portals provide users an entrance and guide into the vast resources of the Internet. Typically, an Internet portal provides a range of search, email, news, shopping, chat, maps, finance, entertainment, and other content and services. The Internet portal may further provide advertising information supplied by advertising entities, which target the users of the portal. Online advertising may be an important source of revenue for enterprises engaged in electronic commerce. A number of different kinds of web page based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a web page to be configured to contain a location for inclusion of an advertisement. A page may not only be a web page, but any other electronically created page or document. An advertisement can be selected for display each time the page is requested, for example, by a browser or server application.

Online advertising may be linked to online searching at the Internet portal. Online searching is a common way for consumers to locate information, goods, or services on the Internet. A consumer may use an online search engine to type in a query to search for other pages or web sites with information related to that query. When the advertising that is shown on the search engine page is related to the query, the search may be referred to as a sponsored search. Sponsored searching may require advertisers to bid for search keywords, which are associated with the search query for displaying advertisements with the search results. The search query may need to be rewritten for a variety of reasons, including potential misspellings or to match with a search keyword.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a block diagram of an exemplary network system;

FIG. 2 is a flow diagram of query mapping;

FIG. 3 is block diagram of a query write engine;

FIG. 4 is a block diagram of an alternative query write engine;

FIG. 5 is a flow diagram of an exemplary query mapping; and

FIG. 6 is a flow diagram of an exemplary generation of a mapping.

### DETAILED DESCRIPTION

By way of introduction, included below is a system and method for query writing in sponsored search. Substitute queries or query rewrites may be identified and used to maximize advertising revenue. A plurality of queries may be analyzed and mapped with bid phrases. The bid phrases may be search keywords that are associated with at least one advertisement. The mapping may associate queries with a particular bid phrase which is associated with at least one advertisement. The generation of the mapping may be performed offline to improve sponsored search results.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

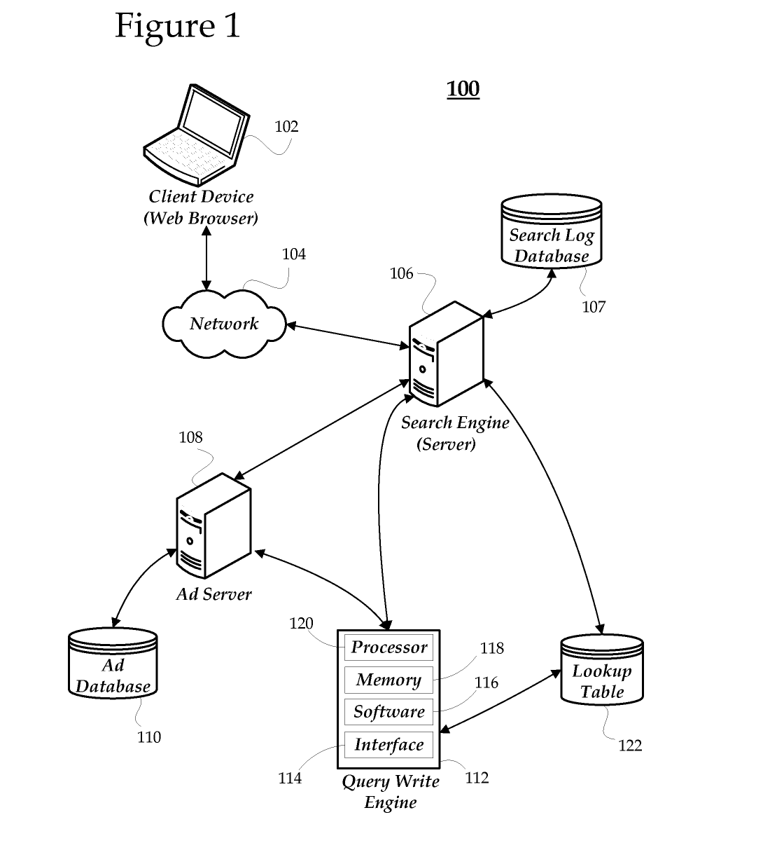

FIG. 1 provides a simplified view of a network system 100 in which the present system and methods may be implemented. Not all of the depicted components may be required, however, and some systems may include additional, different, or fewer components not shown in the figure may be provided. Variations in the arrangement and type of the components may be made without departing from the spirit or scope of the claims as set forth herein.

FIG. 1 is a block diagram illustrating an exemplary network system 100 for query write generation and mapping. In particular, system 100 includes a query write engine 112 that may generate a mapping of queries with bid phrases that is stored as a lookup table 122. A client device 102 is coupled with a search engine 106 through a network 104. The search engine 106 may be coupled with a search log database 107, the lookup table 122 and/or the query write engine 112. An ad server 108 may be coupled with the search engine 106, the query write engine 112, and/or an ad database 110 . Herein, the phrase “coupled with” may mean directly connected to or indirectly connected through one or more intermediate components. Such intermediate components may include both hardware and software based components. Variations in the arrangement and type of the components may be made without departing from the spirit or scope of the claims as set forth herein.

The client device 102 may be a computing device for a user to connect to a network 104, such as the Internet. Examples of a user device include but are not limited to a personal computer, personal digital assistant (“PDA”), cellular phone, or other electronic device. The client device 102 may be configured to access other data/information in addition to web pages over the network 104 with a web browser, such as INTERNET EXPLORER (sold by Microsoft Corp., Redmond, Wash.). The client device 102 may enable a user to view pages over the network 104, such as the Internet.

The client device 102 may be configured to allow a user to interact with the search engine 106, ad server 108, query write engine 112, or other components of the system 100. The client device 102 may receive and display a site or page provided by the search engine 106, such as a search page or a page with search results. The client device 102 may include a keyboard, keypad or a cursor control device, such as a mouse, or a joystick, touch screen display, remote control or any other device operative to allow a user to interact with the page(s) provided by the search engine 106 and/or the ad server 108.

The search engine 106 is coupled with the client device 102 through the network 104, as well as being coupled with the search log database 107, the query write engine 112, the ad server 108 and/or the lookup table 122. The search engine 106 may be a web server. The search engine 106 may provide a site or a page over a network, such as the network 104 or the Internet. A site or page may refer to a web page or web pages that may be received or viewed over a network. The site or page is not limited to a web page, and may include any information accessible over a network that may be displayed at the client device 102. A site may refer to a series of pages which are linked by a site map. For example, the web site of www.yahoo.com (operated by Yahoo! Inc., in Sunnyvale, Calif.) may include thousands of pages, which are included at yahoo.com. Hereinafter, a page will be described as a web page, a web site, or any other site/page accessible over a network. A user of the client device 102 may access a page provided by the search engine 106 over the network 104. As described below, the page provided by the search engine 106 may be a search page that receives a search query from the client device 102 and provides search results that are based on the received search query and may include advertisements associated with the search query.

The search engine 106 may include an interface, such as a web page, e.g., the web page which may be accessed on the World Wide Web at yahoo.com, which is used to search for pages which are accessible via the network 104. The client device 102, autonomously or at the direction of the user, may input a search query (also referred to as a user query, original query, search term or a search keyword) for the search engine 106. A single search query may include multiple words or phrases. The search engine 106 may perform a search for the search query and display the results of the search on the client device 102. The results of a search may include a listing of related pages or sites that is provided by the search engine 106 in response to receiving the search query.

The ad server 108 is coupled with the search engine 106, the ad database 110 and/or the query write engine 112. The ad server 108 may be configured to provide advertisements to the search engine 106. Alternatively, the search engine 106 and the ad server 108 may be a common component and/or the search engine 106 may select and provide advertisements. The ad server 108 may include or be coupled with the advertisement database 110, which includes advertisements that are available to be displayed by the search engine 106 for sponsored searching. The ad server 108 may be configured to transmit and receive content including advertisements, sponsored links, integrated links, and/or other types of advertising content to and from the search engine 106, the ad database 110, and/or the client device 102.

When a user enters a query, ads may be selected by various approaches. For example, exact match may select ads where the bid phrase matches the query and broad match may be analogous to web search in that given a query, the selected ads may be matched with the user's intent expressed by the query rather than the exact wording of the query. Keyword advertising or sponsored searching may include the purchase or bidding of search keywords (bid phrases); such that when that bid phrase is entered as a query a particular advertisement is displayed with the search results as in exact match. The purchase or bidding may create an association between that bid phrase and the advertisement. The advertisements may be associated with one or more search keywords or bid phrases. The bid phrases may be purchased or bid on by advertisers. Each bid phrase may be associated with a bid amount that indicates the maximum amount of money the advertiser is willing to pay for each click on the ad when the user has searched for that bid phrase. Multiple advertisers may bid on or purchase a bid phrase, such that the bid phrase is associated with multiple ads. Likewise, a particular ad may be associated with bid phrases. Accordingly, queries in the lookup table 122 may be associated with a bid phrase which is associated with one or more ads.

When a bid phrase is searched for, the advertisers who placed bids may be placed in competition for display of their advertisements. The rank order of the advertisements may be determined by various factors, some of which not only include the bid price or purchase price, but also include the quality, popularity, relevance, budget, click-through rate (CTR), cost-per-click (CPC), CTR*CPC, similarity, and/or profitability of the ad. A search query may be received and associated bid phrases may be identified as in broad match. In other words, a search query may be rewritten or substituted with a bid phrase, so that the bid phrase is a query rewrite of the original user query. Alternatively, other input may be received for which a query write is selected. The input may include an original query or other information. As described, the input is a query and the query write is a query rewrite that is a potential substitute query for the original query. The ad server 108 may select and provide advertisements to the search engine 106 based on the substituted query rewrite or bid phrase.

Other network entities may also access the search engine 106 and/or the query mapper 112 via the network 104, such as, for example, publisher entities (not shown), which may communicate with a web server (such as the search engine 106) to populate web pages transmitted by the server with appropriate content information, and advertiser entities (not shown), which may communicate with the web server (such as the search engine 106) and/or the ad server 108 to transmit advertisements to be displayed in the web pages requested by the user as the client device 102. The advertiser entity may operate the ad server 108 and the ad database 110. The ad server 108 and the ad database 110 may include ads from a variety of advertisers or advertiser entities.

The search log database 107 includes records or logs of at least a subset of the search queries entered in the search engine 106 over a period of time and may also be referred to as a search query log, search term database, keyword database, bid phrase database or query database. The search log database 107 may store the bid phrases that are used by the ad server 108 in selecting an advertisement for a particular search query. The search log database 107 may also store a history of past queries which may be utilized by the query write engine 112 for generating a mapping between queries and bid phrases. The mapping between queries and bid phrases may be stored in the lookup table 122. The search log database 107 may include associations between bid phrases and advertisements provided by the ad server 108. Alternatively, the ad database 110 may store associations between bid phrases and advertisements. The search log database 107 may include or be coupled with the ad database 110 that includes advertisements provided to the search engine 106. The search log database 107 may include search queries from any number of users over any period of time.

The lookup table 122 may include a mapping that associates a plurality of search queries with bid phrases as discussed below. The lookup table 122 may be coupled with the query write engine 112 and the search engine 106. Alternatively, the lookup table 122 may be stored in the search log database 107. Search queries may be associated with or mapped to bid phrases, such that when a user searches for a particular search query, the mapped or associated bid phrase may be used in selecting search results and/or advertisements in response to that particular search query. The bid phrases stored in the lookup table 122 may be query rewrites for the original user queries in the mapping. Accordingly, the search engine 106 may utilize the lookup table for identifying a query rewrite for a received user query.

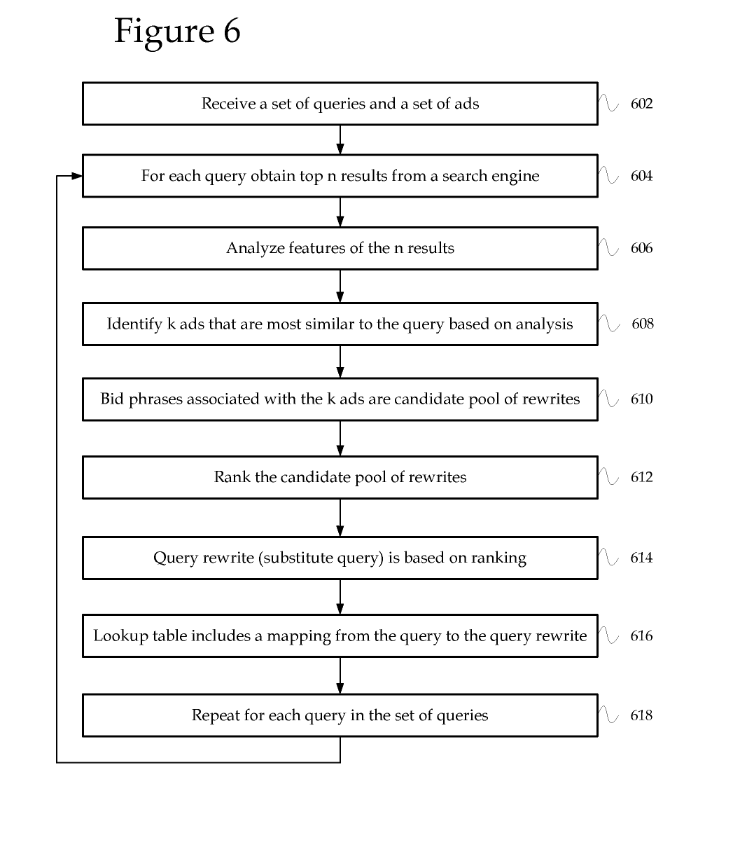

A query rewrite may be a substitute query for a given query. For example, when a user submits a query to the search engine 106, that query may be substituted for a more common word, such as a bid phrase. Query rewriting may be used as a mechanism to improve the relevance and click yield of keyword/bid phrase advertising and/or sponsored searching. Query rewriting may simplify and/or improve the relevance of a user query by replacing it with a substitute query rewrite, such as a bid phrase. It may be difficult to determine the relevance of every ad with respect to every query received. A query mapping between queries and bid phrases may be used to associate queries with bid phrases which are associated with ads. The generation of a mapping is described below with respect to the query write engine 112 and one example is described with respect to FIG. 6. Alternatively, other methods may be used for identifying an association between a query and a bid phrase.

Query rewrites may be used to identify bid phrases on the mapping and likewise to identify ads associated with those bid phrases. Because advertisers may manually or automatically modify when and how their ads are displayed, including which bid phrases their ads are associated with, such that the ad selection process may be dynamic. Although, a single ad may be associated with a small number of bid phrases, the mapping may result in hundreds or thousands of different potential queries being rewritten into that bid phrase.

The search engine 106, the ad server 108, the search engine 102 and/or the lookup table 122 may be coupled with the query write engine 112. The query write engine 112 may be a computing device for analyzing queries and generating a mapping with bid phrases stored in the lookup table 122. The generation of a mapping between queries and bid phrases may be based on an analysis of search histories stored in the search log database 107. The bid phrases may be chosen by advertisers and stored in the ad database 110 with their associated ads.

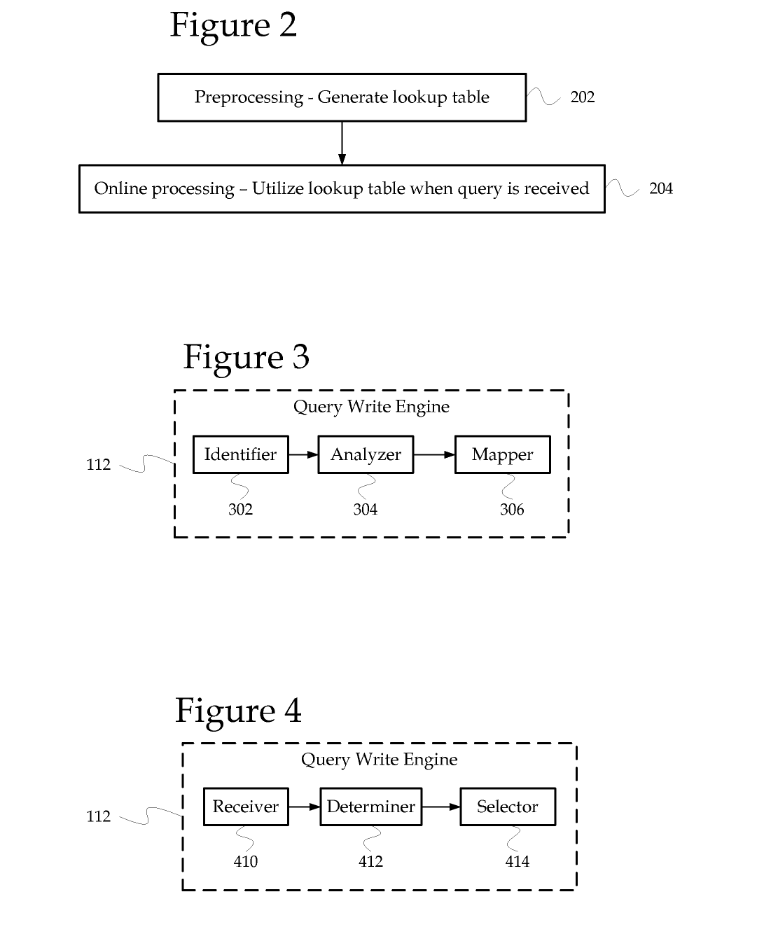

FIG. 2 is a flow diagram of query mapping. In block 202, the mapping may be generated in preprocessing. The preprocessing may include an offline generation of the mapping based on a variety of additional information that is stored in the lookup table 122. Because the analysis of mapping or associating queries with bid phrases may be relatively slow, the analysis may be performed with offline preprocessing, so that the search results are not slowed down. The preprocessing may also consider an analysis of additional knowledge or information. For example, pseudo-relevance feedback may be used to expand the query representation based on Web search results and used to identify a set of representative candidate ads. These ads may provide a set of candidate bid phrases that are relevant to the query. The quality of these bid phrases may be measured using several sources of additional knowledge, such as frequency statistics of ads and bid phrases, similarity of queries and bid phrases with respect to an external taxonomy of commercial topics, and the bid amounts of candidate ads. This use of external knowledge may increase ad revenue without sacrificing ad relevance and without impending time constraints on future searching.

In block 204, the lookup table may be utilized when a query is received. The online processing may occur when a query is received by the search engine 106, which provides results/ads relatively quickly. Referencing the preprocessed lookup table 122 may be more efficient than recreating the query substitution during online processing of the search. When the query is received the search engine 106 may refer to the mapping stored in the lookup table 122 to identify a bid phrase which may be used as a substitute query for the original user query for providing search results or for providing ads to be displayed with the search results. As discussed, the bid phrases in the mapping may include one or more advertisements that they are associated with. Those advertisements may be displayed when the bid phrase is searched for or when a query is rewritten as the bid phrase based on the mapping. The two stage approach illustrated in FIG. 2 may be based on the query write engine 112 generating the mapping stored in the lookup table 122 offline, so that it is available to the search engine 106 for a quick query rewrite when a search is received.

Referring back to FIG. 1, the query write engine 112 may include a processor 120, memory 118, software 116 and an interface 114. The query write engine 112 may be a separate component from the search engine 106, the ad server 108, and/or the lookup table 122. Alternatively, any of the query write engine 112, the search engine 106, the ad server 108, and/or the lookup table 122 may be combined as a single component or device. The interface 114 may communicate with any of the search engine 106, the ad server 108, the lookup table 122, and/or the search log database 107. The interface 114 may include a user interface configured to allow a user to interact with any of the components of the query write engine 112. For example, a user may be able to modify the mapping stored in the lookup table 122 and/or modify ad associations between bid phrases and ads that are used by the query write engine 112.

The processor 120 in the query write engine 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to computer readable storage media such as various types of volatile and non-volatile storage media, including to random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for generating a mapping that is used for query rewriting for improved sponsored searching.

The interface 114 may be a user input device or a display. The interface 114 may include a keyboard, keypad or a cursor control device, such as a mouse, or a joystick, touch screen display, remote control or any other device operative to interact with the query write engine 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the query write engine 112 to view or modify the generation of the query mapping.

Any of the components in system 100 may be coupled with one another through a network. Any of the components in system 100 may include communication ports configured to connect with a network. The present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port or may be a separate component. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or a WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the ad server 108 or the search engine 106 may provide pages to the client device 102 over a network, such as the network 104.

The ad server 108, the ad database 110, the search engine 106, the search log database 107, the query write engine 112, the lookup table 122, and/or the client device 102 may represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, as discussed above. For example, the client device 102 may be configured to execute a browser application that employs HTTP to request information, such as a web page, from the search engine 106 or ad server 108. The present disclosure contemplates a computer-readable medium that includes instructions or receives and executes instructions responsive to a propagated signal, so that any device connected to a network can communicate voice, video, audio, images or any other data over a network.

FIG. 3 is block diagram of the query write engine 112. The query write engine 112 may generate the mapping stored in the lookup table 122. The query write engine 112 may include an identifier 302, an analyzer 304, and a mapper 306. The identifier 302 may identify connections or associations based on the search history stored in the search log database 107. In addition, the identifier 302 may identify connections or associations based on the ads stored in the ad database 110. The analyzer 304 may analyze the search log database 107 and/or the ad database 110 to identify associations between a particular query with a bid phrase and/or ad. For example, if a search for a user query generates search results that are related to a particular topic or category, then bid phrases related to that topic may be query rewrites for the user query. Likewise, search results generated for the query may be utilized to identify a related bid phrase. Alternatively, if a search for a user query generates search results that include ads, then all the bid phrases associated with those ads may be candidates for query rewrites or mappings of the user query.

The mapper 306 may select bid phrases to be associated with the user query based on a variety of factors including similarity, popularity, popularity of associated ads, and/or revenue/profitability of associated ads. The mapper 306 records a selected bid phrase as being associated with the user query, so that in future search requests for that user query, the bid phrase may be a query rewrite that improves the search results and the associated ads that are displayed with the search results. As discussed below, FIG. 6 is a flow diagram of an exemplary mapping generation.

FIG. 4 is a block diagram of an alternative example of the query write engine 112. As illustrated, the query write engine may utilize the lookup table 122 for identifying query rewrites. The query write engine 112 may be a common component with the search engine 106 and/or the ad server 108. Accordingly, the search engine 106 may be in communication with the lookup table 122 for identifying query rewrites. The query write engine 112 may include a receiver 410, a determiner 412, and a selector 414. The receiver 410 may receive a user query from the search engine 106, which may receive the user query from the client device 102. The receiver 402 may also receive or access the mapping stored in the lookup table 122. The determiner 412 may scan the lookup table to identify whether the user query is mapped in the lookup table 122. When the user query is present in the mapping, the selector 414 selects the mapped bid phrase from the lookup table 122 as a query rewrite for the user query. That mapped bid phrase may be used to identify search results. The selector 414 may also select ads from the ad database 110 to be displayed based on the mapped bid phrase.

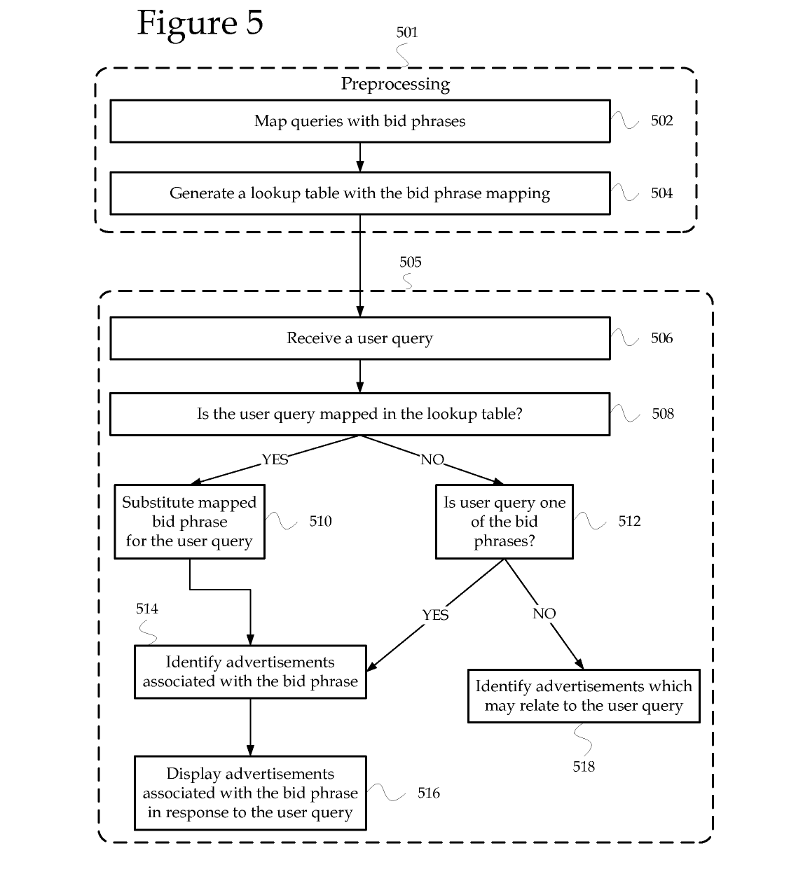

FIG. 5 is a flow diagram of an exemplary query mapping. In block 502, the mapping between queries and bid phrases is created. In block 504, the bid phrase mapping is stored in the lookup table 122. The lookup table 122 may store the mapping as a connection between potential queries and an associated bid phrase. Each stored query may be associated with one bid phrase, but each bid phrase may have multiple associations with queries. Alternatively, each query may be associated with multiple bid phrases and those bid phrases may be ranked. The ranking may be based on relevance, similarity, or based on the ads that are associated with the bid phrases. The mapping stored in the lookup table 122 may be a comprehensive list of queries based on the search history from the search log database 107.

In block 506, a user query is received. A user of the client device 102 may submit a search query to the search engine 106. The search engine 106 may reference the lookup table 122 to make a determination as to whether the user query is mapped in the lookup table 122 as in block 508. Alternatively, the search engine 106 may communicate with the query write engine 112 to determine whether the query is mapped in the lookup table 122. When the user query is mapped with a bid phrase in the lookup table 122, the mapped bid phrase may be a query rewrite for the user query as in block 510. Conversely, if the user query is not mapped as a query in the lookup table 122, the query may be checked to see if it is one of the bid phrases as in block 512. If the query is a bid phrase, or when the query is substituted with a bid phrase, that bid phrase is used to identify associated advertisements as in block 514. In block 516, those associated ads may be displayed with search results in response to the user query. Accordingly, the search engine may provide search results and/or ads that are based on the identified bid phrase. In block 512, if the user query is not a bid phrase, then no bid phrase is associated with the user query and search results and/or ads will be identified through other techniques as in block 518. In one example, the mapping with a bid phrase may be used for identification of relevant/popular ads to be displayed with a number of queries.

FIG. 6 is a flow diagram of an exemplary generation of a mapping. As discussed, a mapping may be stored in the lookup table 122 that associates a number of queries with bid phrases. That association may be based on an analysis of historical search and/or advertisement records. In block 602, a set of queries and a set of ads may be received. The queries may be received from the search log database 107 and the ads may be retrieved from the ad database 110. Additional information may be included with the set of ads, such as the associated bid phrases that may determine when the ads are displayed. Each ad may be associated with a plurality of bid phrases.

Each query from the set of queries may be input into the search engine 106 and the top n results may be obtained as in block 604. The value of n may be any number of search results, such as ten results. The n results may be analyzed as in block 606. In one example, the n results are analyzed and the words in those results are extracted. The more frequently used words may be ranked or weighted. The weights may be adjusted depending on the location of the words, such as title words, description words, bid phrase words or URL words may be weighted differently. A set of candidate advertisements may also be analyzed similarly by identifying the more common words in the set of candidate ads and ranking/weighting those words. The similarity between common words of the n results and the candidate set of ads may be used to identify the k ads that are most similar to the original query as in block 608. In one example, the cosine similarity may be used to rank the similarity between the words from the n results and the words from the candidate set of ads. In block 610, the bid phrases associated with the k ads may be used as the candidate pool of potential query rewrites.

The candidate pool of potential query rewrites may be ranked in block 612. The ranking may be based on the similarity that the k ads share with the original query. The more similar ads may be ranked higher, and likewise the bid phrases associated with higher ranked ads are also ranked higher. The ranking may be based on a similarity score between the original query and any advertisement in the corpus using the cosine similarity. Alternatively, the cosine similarity of the concatenation of the abstracts of the top n search results for the query may be compared with the abstracts of the top n search results for a potential query rewrite or bid phrase. The similarity may also be measured and compared when the queries are classified in a taxonomy. The ranking may used to maximize revenue for the search engine. For example, the number of ads that bid on a particular query rewrite, the number of clients who bid on a query rewrite, and/or the bid amounts for a query rewrite may be an indication of the popularity and/or profitability of a query rewrite. Ranking query rewrites by popularity and/or profitability may increase revenue for the search engine.

Higher ranked queries may be used as the query rewrite as in block 614. The original query and the selected query rewrite, which is also a bid phrase, may be mapped in the lookup table 122 for future reference as in block 616. In block 618, the process is repeated for a different query from the set of queries. Accordingly each of the queries from the set of queries may be mapped with a bid phrase in the lookup table 122.

The similarity between a query and a bid phrase or an advertisement may be determined in various ways. In one example, the quality of match between a query and query rewrite may be measured with a lexical or semantic similarity. As described above, semantic similarity may be measured, for example, by whether the original query and candidate substitution return similar search results. In one example, the query substitution or rewrite may be made so that profitable advertisements are shown. The lexical features that may be used to measure a match between a query and a query rewrite include: 1) whether they share words, 2) word changes between them, 3) cosine similarity, 4) character changes, or 5) cosine similarity after removing white space.

The system and process described may be encoded in a signal bearing medium, a computer readable medium such as a memory, programmed within a device such as one or more integrated circuits, one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for mapping queries comprising:
mapping the queries with bid phrases, wherein each of the queries is mapped to at least one of the bid phrases in a lookup table, wherein the lookup table is referenced when a user query is received;
receiving the user query;
determining whether the user query is mapped in the lookup table or whether the user query comprises a bid phrase;
identifying a mapped bid phrase in the lookup table when the user query is mapped in the lookup table; and
identifying one or more advertisements associated with the mapped bid phrase or associated with the user query when the user query comprises a bid phrase.

2. The method of claim 1 wherein the mapping queries with bid phrases further comprises measuring a quality of the bid phrases based on additional knowledge.

3. The method of claim 2 wherein the additional knowledge comprises a popularity of the associated advertisements for the bid phrase, a bid amount of the associated advertisements for the bid phrase, a similarity between the mapped query with its mapped bid phrase, or combinations thereof.

4. The method of claim 1 wherein the mapping in the lookup table is generated in preprocessing before the user query is received.

5. The method of claim 4 wherein processing of the user query utilizes the preprocessed lookup table.

6. The method of claim 1 wherein the bid phrases comprise a plurality of potential user queries.

7. The method of claim 1 wherein the bid phrases are associated with one or more advertisements.

8. The method of claim 7 wherein the one or more advertisements are displayed when the associated bid phrase is received as a user query or when the received user query is mapped to the associated bid phrase in the lookup table.

9. The method of claim 1 wherein the lookup table substitutes a user query with a bid phrase.

10. A method for writing queries comprising:
receiving a user input;
determining whether the user input is mapped with a bid phrase in a lookup table;
substituting a mapped bid phrase for the user input when the user input is mapped in the lookup table; and
selecting advertisements to be displayed with results for the user input, wherein the selected advertisements are associated with the mapped bid phrase.

11. The method of claim 10 wherein the user input comprises a user query.

12. The method of claim 11 further comprising determining whether the user query is one of the bid phrases in the lookup table.

13. The method of claim 12 wherein the mapped bid phrase comprises the user query when the user query is one of the bid phrases in the lookup table.

14. The method of claim 11 wherein the bid phrase comprises a potential user query.

15. The method of claim 10 wherein the mapping in the lookup table is generated in preprocessing before the user input is received.

16. The method of claim 10 wherein the selected advertisements are displayed with search results in response to receiving the user input.

17. A query rewrite system comprising:
a network;
a search engine in communication with the network that receives a user query and provides results for the received user query;
a database in communication with the search engine that stores a lookup table that associates a plurality of potential user queries with bid phrases; and
a query write engine in communication with the database and the search engine, the query write engine substituting a bid phrase for the received user query based on the lookup table unless the received user query comprises one of the bid phrases, further wherein the substituted bid phrase determines the provided results.

18. The system of claim 17 wherein the query write engine substitutes a bid phrase for the received user query when the user query comprise one of the potential user queries.

19. The system of claim 17 wherein the results comprise advertisements associated with the received user query.

20. The system of claim 17 further comprising an ad server in communication with the search engine and the query write engine the provides the advertisements to the search engine.

21. The system of claim 17 wherein the database generates the lookup table in preprocessing, wherein the lookup table is referenced upon receiving the user query.
